(19) United States
(12) Patent Application Publication
(10) Pub. No.: US 2026/0127899 A1
(43) Pub. Date: May 7, 2026

(54) APPARATUS AND METHOD FOR MONOCULAR 3D OBJECT DETECTION USING WEATHER-ADAPTIVE DIFFUSION MODELS

(71) Applicant: ELECTRONICS AND TELECOMMUNICATIONS RESEARCH INSTITUTE, Daejeon (KR)

(72) Inventors: Hyungil Kim, Daejeon (KR); Seong Tae Kim, Daejeon (KR); Jung Uk Kim, Daejeon (KR); Youngmin Oh, Daejeon (KR)

(21) Appl. No.: 19/379,326

(22) Filed: Nov. 4, 2025

(30) Foreign Application Priority Data
Nov. 5, 2024 (KR) 10-2024-0155302

(51) Int. Cl. G06V 20/64; G06N 3/0464; G06N 3/048; G06N 3/08; G06V 20/10

(52) U.S. Cl. CPC G06V 20/64; G06N 3/0464; G06N 3/048; G06N 3/08; G06V 20/10

(57) ABSTRACT

Disclosed herein are an apparatus and method for monocular 3D object detection using weather-adaptive diffusion models. The apparatus for monocular 3D object detection includes an encoder configured to encode input features of input images, a weather codebook configured to generate weather reference features, which contain knowledge of reference weather and indicate a degree of enhancement for the input features, a weather-adaptive diffusion model configured to obtain enhanced features by enhancing the input features with reference to the weather reference features, and a detection block configured to perform monocular 3D object detection using the enhanced features.

### CROSS-REFERENCE TO RELATED APPLICATION

The present application claims priority to and the benefit of Korean Patent Application No. 10-2024-0155302, filed on Nov. 5, 2024, in the Korean Intellectual Property Office, the entire disclosure of which is incorporated herein by reference.

### BACKGROUND

### 1. Technical Field

The present disclosure relates to an apparatus and method for monocular 3D object detection using weather-adaptive diffusion models.

### 2. Description of Related Art

Monocular 3D object detection is intended to detect 3D objects using only a single camera. Unlike LiDAR-based methods that use expensive LiDAR sensors for depth estimation and stereo-based methods that require synchronized stereo cameras, the monocular 3D object detection requires only monocular images, resulting in lower computational costs and fewer resources. Due to these characteristics, the monocular 3D object detection is being applied to various real-world applications such as autonomous vehicles and robotics.

However, existing monocular 3D object detectors mainly focus on ideal autonomous driving environments such as clear weather. Hence, it is difficult to apply these detectors to real-world situations with bad weather conditions such as fog or rain. Among others, fog presents the biggest challenge compared to other types of weather. This is because fog is dense and diffuse, causing difficulty in object detection due to its characteristics of strongly scattering and absorbing light. Since the monocular 3D object detection relies solely on visual information from monocular images, unlike with LiDAR, it is important to design detectors to achieve improved performance even in low-visibility situations such as fog.

### SUMMARY

The present disclosure is intended to overcome problems with conventional 3D object detection technology that suffers from performance degradation when it is applied to real-world environments with extreme changes in weather such as snow, rain, and fog that do not exist in learning environments, and an object of the present disclosure is to provide an apparatus and method for monocular 3D object detection that are resistant to weather.

In accordance with an aspect of the present disclosure, there is provided a method for monocular 3D object detection, which includes encoding input features of input images, generating weather reference features that contain knowledge of reference weather and indicate a degree of enhancement for the input features by a weather codebook, obtaining enhanced features by enhancing the input features with reference to the weather reference features by a weather-adaptive diffusion model, and performing monocular 3D object detection using the enhanced features by a detection block.

The weather codebook may be trained through a weather codebook training phase. The weather codebook training phase may include randomly initializing embedding weight parameters of the weather codebook, obtaining a first enhanced feature by passing a first feature through a convolutional layer, obtaining a first weather reference feature through a quantization process on each element of the first enhanced feature, performing softmax and global average pooling (GAP) on the first feature and the first weather reference feature to generate first and second probabilities representing importance of each channel, respectively, and training the weather codebook through use of a clear knowledge embedding (CKE) loss function calculated using Kullback-Leibler divergence for the first and second probabilities.

The weather codebook training phase may further include obtaining a second enhanced feature by passing a second feature through a convolutional layer, obtaining a second weather reference feature through the quantization process on each element of the second enhanced feature, and training the weather codebook through use of a weather-invariant guiding (WIG) loss function that guides the second feature to be memorized as a feature of first weather using the first and second weather reference features.

In the weather codebook training phase, the weather codebook may be trained using a clear knowledge recalling (CKR) loss function that adds the CKE loss function and the WIG loss function.

The weather-adaptive diffusion model may be trained by performing forward and reverse processes in multiple time steps of fixed Markov Chain, and use only the reverse process in its inference phase.

The weather-adaptive diffusion model may be diffused using noise obtained by subtracting the first feature from the second feature for each of the multiple time steps in the forward process.

The weather-adaptive diffusion model may generate the enhanced features by removing noise using a conditional autoencoder that receives a second feature at each corresponding one of the multiple time steps and the weather reference features from the weather codebook in the reverse process.

The weather-adaptive diffusion model may calculate similarity between the input features and the weather reference features and transfer its enhancement to the input features.

The weather-adaptive diffusion model may be trained using the following weather-adaptive enhancement (WAE) loss function that enables estimation of fog variants through several forward and reverse processes,

$${L}_{wae} = {E}_{{x}^{c} , {ϵ}_{n} \sim F , t} [ {‖ {ϵ}_{n} - {ϵ}_{θ} ( {x}_{t}^{c} , t , {x}^{r} ) ‖}_{2}^{2} ]$$

where ∈ₙ is noise obtained by subtracting the second feature from the first feature, ∈_{θ} is estimated noise,

$${x}_{t}^{c}$$

is a first feature at a t-th time step, and x^{r} is a weather reference feature.

The reference weather may be clear weather. The first feature may be a clear feature, the second feature may be a foggy feature, the first enhanced feature may be an enhanced feature for clear weather, and the second enhanced feature may be an enhanced feature for foggy weather.

In accordance with another aspect of the present disclosure, there is provided an apparatus for monocular 3D object detection, which includes an encoder configured to encode input features of input images, a weather codebook configured to generate weather reference features, which contain knowledge of reference weather and indicate a degree of enhancement for the input features, a weather-adaptive diffusion model configured to obtain enhanced features by enhancing the input features with reference to the weather reference features, and a detection block configured to perform monocular 3D object detection using the enhanced features.

The weather codebook may be trained through a weather codebook training phase that includes randomly initializing embedding weight parameters of the weather codebook, obtaining a first enhanced feature by passing a first feature through a convolutional layer, obtaining a first weather reference feature through a quantization process on each element of the first enhanced feature, performing softmax and global average pooling (GAP) on the first feature and the first weather reference feature to generate first and second probabilities representing importance of each channel, respectively, and training the weather codebook through use of a clear knowledge embedding (CKE) loss function calculated using Kullback-Leibler divergence for the first and second probabilities.

The weather codebook training phase may further include obtaining a second enhanced feature by passing a second feature through a convolutional layer, obtaining a second weather reference feature through the quantization process on each element of the second enhanced feature, and training the weather codebook through use of a weather-invariant guiding (WIG) loss function that guides the second feature to be memorized as a feature of first weather using the first and second weather reference features.

In the weather codebook training phase, the weather codebook may be trained using a clear knowledge recalling (CKR) loss function that adds the CKE loss function and the WIG loss function.

The weather-adaptive diffusion model may be trained by performing forward and reverse processes in multiple time steps of fixed Markov Chain, and use only the reverse process in its inference phase.

The weather-adaptive diffusion model may be diffused using noise obtained by subtracting the first feature from the second feature for each of the multiple time steps in the forward process.

The weather-adaptive diffusion model may generate the enhanced features by removing noise using a conditional autoencoder that receives a second feature at each corresponding one of the multiple time steps and the weather reference features from the weather codebook in the reverse process.

The weather-adaptive diffusion model may calculate similarity between the input features and the weather reference features and transfer its enhancement to the input features.

The weather-adaptive diffusion model may be trained using the following weather-adaptive enhancement (WAE) loss function that enables estimation of fog variants through several forward and reverse processes,

$${L}_{wae} = {E}_{{x}^{c} , {ϵ}_{n} \sim F , t} [ {‖ {ϵ}_{n} - {ϵ}_{θ} ( {x}_{t}^{c} , t , {x}^{r} ) ‖}_{2}^{2} ]$$

where ∈ₙ is noise obtained by subtracting the second feature from the first feature, ∈_{θ} is estimated noise,

$${x}_{t}^{c}$$

is a first feature at a t-th time step, and x^{r} is a weather reference feature.

The reference weather may be clear weather. The first feature may be a clear feature, the second feature may be a foggy feature, the first enhanced feature may be an enhanced feature for clear weather, and the second enhanced feature may be an enhanced feature for foggy weather.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a configuration of an apparatus for monocular 3D object detection according to an embodiment of the present disclosure;

FIG. 2 is a flowchart illustrating a flow of operation during inference in a method for monocular 3D object detection according to an embodiment of the present disclosure;

FIG. 3 illustrates the flow of operation during inference in the method for monocular 3D object detection according to the embodiment of the present disclosure;

FIG. 4 conceptually illustrates a process of training a weather codebook using a weather-invariant guiding (WIG) loss function;

FIG. 5 conceptually illustrates how to use a clear knowledge embedding (CKE) loss function to enable the weather codebook to memorize knowledge of clear weather; and

FIG. 6 illustrates a weather-adaptive diffusion model training process according to the present disclosure.

### DETAILED DESCRIPTION

The above and other objects, advantages, and features of the present disclosure and methods of achieving them will become apparent with reference to the embodiments described below in detail in conjunction with the accompanying drawings.

The present disclosure may, however, be embodied in different forms and should not be construed as limited to the embodiments set forth herein. The following embodiments are provided solely to facilitate the purpose, configuration and effect of the disclosure to those of ordinary skill in the art to which the present disclosure pertains, and the scope of the present disclosure is defined by the appended claims.

Meanwhile, the terms used herein are for the purpose of describing the embodiments and are not intended to limit the disclosure. As used herein, the singular forms “a”, “an” and “the” are intended to include the plural forms as well, unless context clearly indicates otherwise. It will be understood that the terms “comprises”/“includes” and/or “comprising”/“including” when used in the specification, specify the presence of stated components, steps, motions, and/or elements, but do not preclude the presence or addition of one or more other components, steps, motions, and/or elements.

The following description illustrates examples of weather types and clear and foggy weather, but is applicable to other weather conditions such as rainy weather.

The present disclosure considers the following two key aspects for an apparatus for monocular 3D object detection that is resistant to weather:
(1) how to quantify a degree of improvement required for input images; and
(2) how to guide representations of input images to models.

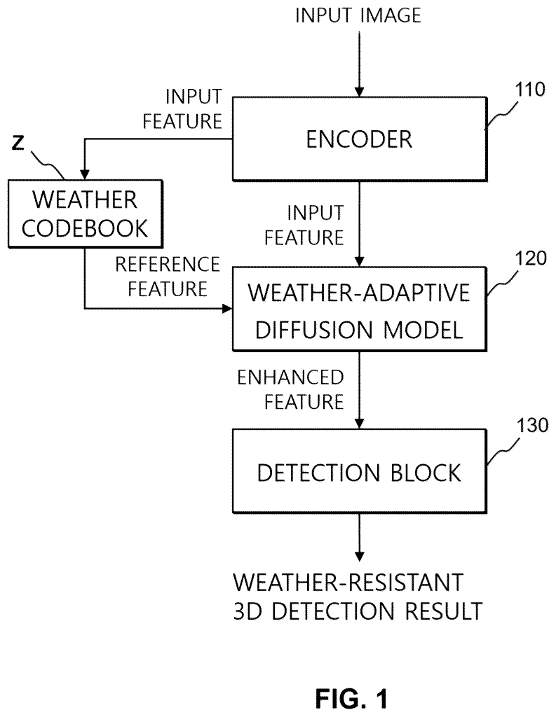

To address these two key aspects, the apparatus for monocular 3D object detection according to the present disclosure includes an encoder 110, a weather codebook Z, a weather-adaptive diffusion model 120, and a detection block 130, as illustrated in FIG. 1. The encoder 110 encodes input features from input images.

The weather codebook Z is a new concept for how to quantify the degree of improvement required for input images in unknown weather conditions. The weather codebook Z learns knowledge of clear weather in its training phase and delivers it to the weather-adaptive diffusion model 120 to improve weather-related contents. No matter what weather image is given, the weather codebook Z may allow weather reference features, which are reference knowledge for appropriate enhancement under weather conditions, to be delivered to the weather-adaptive diffusion model 120.

The weather-adaptive diffusion model 120 effectively enhances feature representations under weather conditions, thereby enabling monocular 3D object detection to adapt to various types of weather. The detection block 130 performs monocular 3D object detection from images whose feature representations are enhanced by the weather-adaptive diffusion model 120.

The weather codebook Z is used to generate weather reference features that contain knowledge of reference weather in a given scene. The reference weather serves as a guide to indicate the degree of required weather improvement.

The clear weather is adopted as reference weather since it contains rich visual representations of objects. A loss function is used to induce the weather codebook Z to memorize information about clear weather and generate weather reference features for all inputs (e.g., clear weather or foggy weather). In an embodiment, a clear knowledge recalling (CKR) loss function may be used. This allows for understanding where improvements are required in input features based on the weather reference features.

The weather-adaptive diffusion model 120 is used to effectively enhance feature representations under weather conditions. For a given input feature (clear weather or foggy weather), the weather-adaptive diffusion model 120 dynamically enhances the representations of input features based on the weather reference features. The weather reference features serve to determine how much the input features need to be enhanced. The weather-adaptive diffusion model 120 of the present disclosure may utilize fog distribution as noise to learn changes in weather and combine knowledge of weather reference features to dynamically enhance feature representations. The weather-adaptive diffusion model may dynamically enhance feature representations regardless of clear or foggy conditions.

In an embodiment, the difference between clear weather and foggy weather (change in weather) is defined as “fog distribution” and adopted as noise in the diffusion model. The weather-adaptive diffusion model 120 may use fog distribution to enhance feature representations under weather conditions through several phases in a reverse process. To achieve this, a weather-adaptive enhancement (WAE) loss function may be used. As a result, the present disclosure may perform weather-resistant 3D detection by adaptively enhancing feature representations under weather conditions.

In an embodiment, the detection block 130 may use a transformer encoder-decoder for implementation.

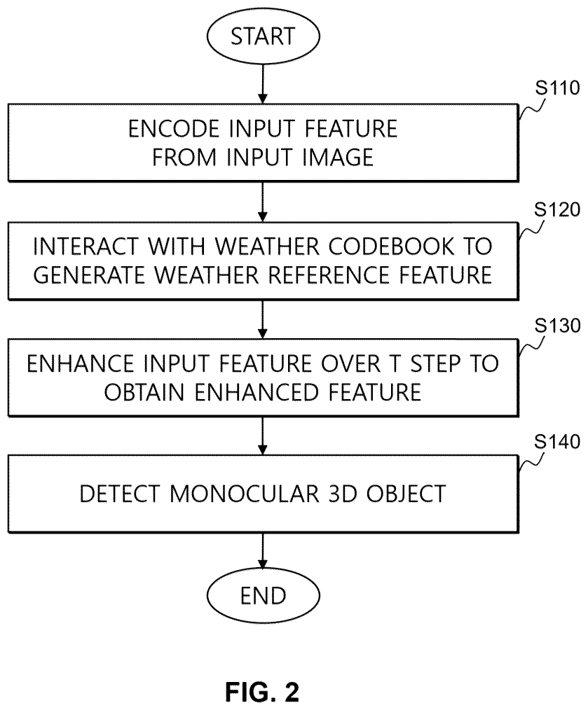

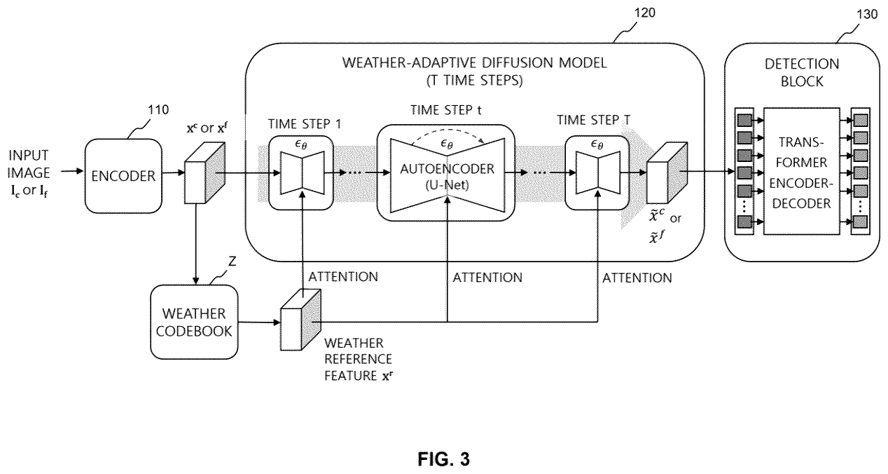

FIGS. 2 and 3 illustrate a flow of operation in an inference phase of the present disclosure. A deep learning network (backbone) receives an input image (clear image I_{c} or foggy image I^{f}) and encodes a corresponding input feature (input clear feature x^{c} or input foggy feature x^{f}) (step S110). Next, a weather codebook Z is used to generate a weather reference feature x^{r} indicative of a degree of improvement for a given input feature (step S120). A weather-adaptive diffusion model 120 enhances the input feature over T steps with reference to the weather reference feature x^{r}, thereby obtaining an enhanced feature \tilde{x}^{c} or \tilde{x}^{f} (step S130). Finally, a detection block 130 performs monocular 3D object detection using the enhanced feature (step S140).

### [Training Process]

In an embodiment, the weather-adaptive diffusion model 120 and the detection block 130 are trained using the clear feature x^{c} in the training phase thereof.

The following description addresses two key issues: (1) how to guide the weather reference feature x^{r} to serve as a reference feature; and (2) how to induce the weather-adaptive diffusion model 120 to effectively enhance feature representations under weather conditions.

### Weather Codebook

In foggy weather, a significant amount of improvement is required because of low visual quality on the whole. On the other hand, compared to in the foggy weather, a relatively less amount of improvement is required in clear weather. The present disclosure provides reference knowledge for appropriate enhancement under weather conditions through the weather codebook Z. It is preferable that the clear weather be utilized as reference weather knowledge since it contains rich visual representations.

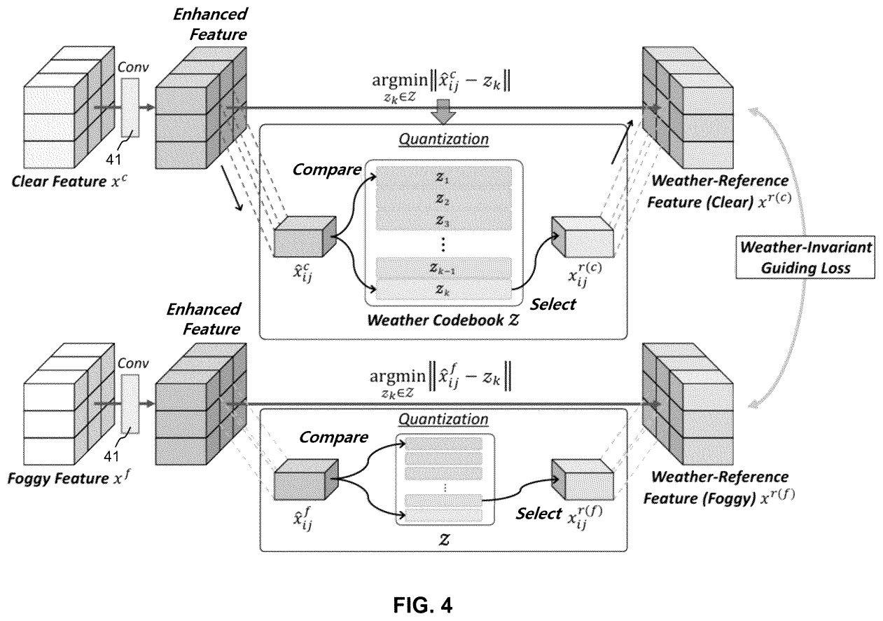

As seen in FIG. 4, the procedure of reference knowledge embedding begins with receiving a pair of clear and foggy features in the training phase.

The weather codebook Z may be composed of K trainable slots and expressed as follows.

$$Z = {\{ {z}_{k} \}}_{k = 1}^{K} ( {z}_{k} ∈ {ℝ}^{1 \times c} )$$

Here, c refers to a dimension of each slot. The paired clear feature x^{c} and foggy feature x^{f} pass through convolutional layers 41 to obtain enhanced features \hat{x}^{c}∈ [symbol] ^{h×w×c} and \hat{x}^{f}∈ [symbol] ^{h×w×c}, respectively. Here, w refers to a width, h refers to a height, and c refers to a dimension.

The respective elements of the enhanced features are denoted by

$${\hat{x}}_{i , j}^{c} ∈ {ℝ}^{1 \times c} and {\hat{x}}_{i , j}^{f} ∈ {ℝ}^{1 \times c} ,$$

and a weather reference feature for clear weather x^{r(c)}∈ [symbol] ^{h×w×c} is then obtained through an element-specific quantization process q(·). This is calculated as in Equation 1 below.

$${x}^{r ( c )} = q ( {\hat{x}}^{c} ) := ( {arg min}_{{z}_{k} ∈ Z} ‖ {\hat{x}}_{i , j}^{c} - {z}_{k} ‖ ) \qquad [ Equation 1 ]$$

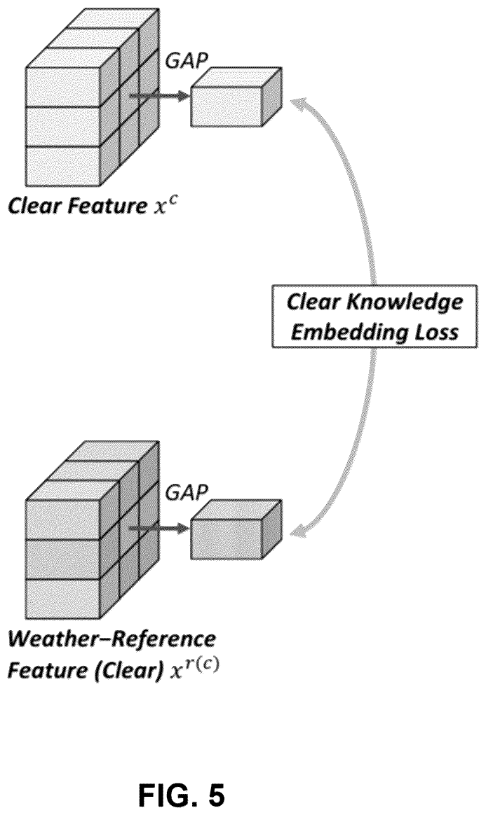

The present disclosure introduces a clear knowledge embedding (CKE) loss function that guides the weather reference feature for clear weather x^{r(c)} to follow the representation of the input clear feature x^{c} by utilizing the input clear feature x^{c} and the weather reference feature for clear weather x^{r(c)} (see FIG. 5). For this purpose, softmax and global average pooling (GAP) are performed on the input clear feature x^{c} and the weather reference feature for clear weather x^{r(c)} to generate s^{c} and s^{r(c)}, respectively. Each element of the s^{c} and s^{r(c)} vectors means a probability representing the importance of each channel. The CKE loss function L_{cke} may be obtained using Kullback-Leibler (KL) divergence for s^{c} and s^{r(c)} D_{KL}(·) as in Equation 2 below.

$${L}_{ckε} = {D}_{KL} ( {s}^{c} ‖ {s}^{r ( c )} ) \qquad [ Equation 2 ]$$

By training the weather codebook Z using the CKE loss function L_{cke}, the weather codebook Z may memorize the knowledge of clear weather, thereby effectively reconstructing the knowledge of clear weather.

Since the image pair of clear weather and foggy weather are identical except for weather conditions, the quantization process of foggy feature x^{f} using the weather codebook should generate identical weather reference features. To obtain a weather reference feature for foggy weather x^{r(f)}, the element-specific quantization process is also performed on the enhanced feature for foggy weather \tilde{x}^{f} and the weather codebook Z as in Equation 3 below.

$${x}^{r ( f )} = q ( {\hat{x}}^{f} ) := ( {arg min}_{{z}_{k} ∈ Z} ‖ {\hat{x}}_{i , j}^{f} - {z}_{k} ‖ ) \qquad [ Equation 3 ]$$

The present disclosure also uses a weather-invariant guiding (WIG) loss function that guides the weather codebook Z to memorize the same knowledge of clear weather for foggy features. This may be expressed as in Equation 4 below.

$${L}_{wig} = {‖ {x}^{r ( c )} - {x}^{r ( f )} ‖}_{2}^{2} \qquad [ Equation 4 ]$$

Finally, a clear knowledge recalling (CKR) loss function for guiding the generation of weather reference features containing the knowledge of clear weather in any weather is obtained by combining the L_{cke} and the L_{wig}, which may be expressed as follows.

$${L}_{ckr} = {L}_{cke} + {L}_{wig} \qquad [ Equation 5 ]$$

The CKR loss function induces the weather codebook Z to recall the knowledge of clear weather, thereby instructing it to generate rich visual representations of clear weather as weather reference features in any input of weather.

In the training phase, the embedding weight parameters of the K slots of the weather codebook Z are randomly initialized and updated by Equation 5. In the inference phase, all parameters are fixed to recall clear weather and weather reference features are generated in any weather.

### Weather-Adaptive Diffusion Model

It has been described previously that the weather codebook Z outputs the weather reference feature for clear weather x^{r(c)} and the weather reference feature for foggy weather x^{r(f)} through the use of Equation 5. The present disclosure may denote the weather reference feature as x^{r} since it receives any input image (clear weather or foggy weather).

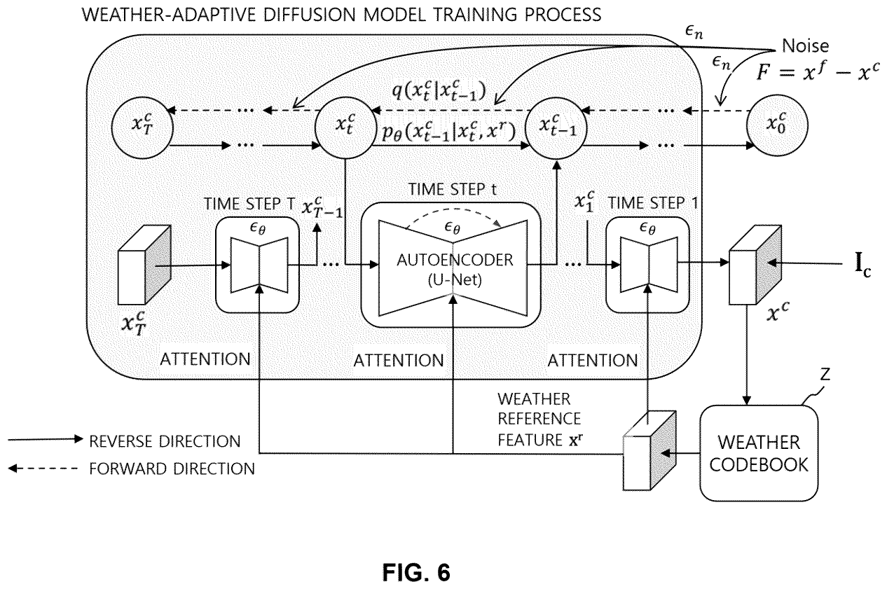

FIG. 6 illustrates the training process of the weather-adaptive diffusion model 120 according to the present disclosure. The diffusion model performs forward and reverse processes in T steps of fixed Markov Chain, and uses only the reverse process in the inference phase.

The present disclosure constructs the weather-adaptive diffusion model 120 to enhance representations related to weather conditions. For this purpose, unlike conventional diffusion methods of applying Gaussian noise to images or latent space, the present disclosure introduces fog distribution F=x^{f}+−x^{c} to enable the weather-adaptive diffusion model 120 to recognize foggy weather. Ideally, the fog distribution F needs to contain information about fog since it represents the difference between a foggy scene and an identical scene in clear weather. This allows the weather-adaptive diffusion model 120 to learn the changes in weather by repeatedly adding and removing fog. Since the clear feature x^{c} is used for x₀ as the reference input of the weather-adaptive diffusion model 120, x₀ is denoted by

$${x}_{0}^{c} .$$

In the forward process at a t-th time step, the previous feature and noise related to the changes in weather are input to generate a feature with fog added. In other words, as shown in Equation 6, at the t-th time step,

$$q ( {x}_{t}^{c} \vert {x}_{t - 1}^{c} )$$

receives the previous feature

$${x}_{t - 1}^{c}$$

and fog-related noise F to generate a t-th feature

$${x}_{t}^{c} .$$

$$q ( {x}_{t}^{c} \vert {x}_{t - 1}^{c} ) = F ( {x}_{t}^{c} ; \sqrt{1 \to {β}_{t}} {x}_{t - 1}^{c} , {β}_{t} I ) \qquad [ Equation 6 ]$$

This process is repeated over T time steps to gradually add fog to the features, which may be expressed as in Equation 7 below.

$$q ( {x}_{1}^{c} , … , {x}_{T}^{c} \vert {x}_{}^{c} ) = \vert {x}^{c} ) = {\prod }_{t = 1}^{T} q ( {x}_{t}^{c} \vert {x}_{t - 1}^{c} ) \qquad [ Equation 7 ]$$

Here, βₜ refers to a parameter that controls the degree of noise (fog) addition.

Next, the reverse process at the t-th time step estimates a fog variant ∈ₙ by making use of a clear feature at the t-th time step

$${x}_{t}^{c}$$

to enhance foggy features. For this purpose, in an embodiment a conditional autoencoder which receives a fog-added feature at the t-th time step

$${x}_{t}^{f}$$

and the weather reference feature x^{r} from the weather codebook Z, is used to generate features with noise removed and enhanced feature representations. Specifically, ∈ₙ estimates a mean μ_{θ} and variance Σ_{θ} of fog distribution at the t-th time step, which is denoted by \tilde{F}(·).

$${p}_{θ} ( {x}_{t - 1}^{c} \vert {x}_{t}^{c} , {x}^{r} ) = \tilde{F} ( {x}_{t - 1}^{c} ; {μ}_{θ} ( {x}_{t}^{c} , t , {x}^{r} ) , {\sum }_{θ} ( {x}_{t}^{c} , t ) \qquad [ Equation 8 ]$$

This reverse process is also repeated over T time steps to gradually remove noise from the features and enhance feature representations, which may be expressed as in Equation 9 below.

$${p}_{θ} ( {x}_{1}^{c} , … , {x}_{T}^{c} ) = p ( {x}_{T}^{c} ) {\prod }_{t = 1}^{T} {p}_{θ} ( {x}_{t - 1}^{c} \vert {x}_{t}^{c} , {x}^{r} ) \qquad [ Equation 9 ]$$

Cross-attention layers receive the clear feature

$${x}_{t}^{c}$$

and the weather reference features x^{r} in flattened forms

$${\overline{x}}_{t}^{c} and {\overline{x}}^{r} ,$$

respectively. The cross-attention layers calculate the similarity between

$${\overline{x}}_{t}^{c} and {\overline{x}}^{r}$$

and transfer its enhancement to the

$${\overline{x}}_{t}^{c} ,$$

which may be expressed as Equation 10 below.

$$Attention ( Q , K , V ) = soft max ( \frac{{QK}^{T}}{\sqrt{d}} ) V \qquad [ Equation 10 ]$$

$$Here , Q = {W}_{i}^{q} \cdot {\overline{x}}_{t}^{c} , K = {W}_{i}^{k} \cdot {\overline{x}}^{r} , V = {W}_{i}^{v} \cdot {\overline{x}}^{r} , and {W}_{i}^{q} ,$$

$${W}_{i}^{v} , and {W}_{i}^{v}$$

refer to learnable parameters.

In an embodiment, the estimated fog variant ∈_{θ} uses a weather-adaptive enhancement (WAE) loss function L_{wae} to make it similar to a fog variant ∈ₙ applied to create

$${x}_{t}^{c}$$

from the input clear feature x^{c}, which may be expressed as in Equation 11 below. The WAE loss function is a loss function that instructs learning of the changes in weather by utilizing the fog distribution as noise through several forward/reverse processes to estimate fog variants.

$${L}_{wae} = {E}_{{x}^{c} , {ϵ}_{n} ∼ F , t} [ {‖ {ϵ}_{n} - {ϵ}_{θ} ( {x}_{t}^{c} , t , {x}^{r} ) ‖}_{2}^{2} ] \qquad [ Equation 11 ]$$

The WAE loss function L_{wae} may allow ∈_{θ} to estimate fog variants by utilizing fog distribution as noise through several forward/reverse processes. In addition, the cross-attention layers within ∈_{θ} dynamically enhance feature representations by combining knowledge of input features (foggy or clear weather) with weather reference features. Since the weather-adaptive diffusion model 120 according to the present disclosure learns the degree of enhancement required under weather conditions, it may enhance feature representations regardless of input clear or foggy conditions in the inference phase.

This enables the apparatus for monocular 3D object detection of the present disclosure to process both clear and foggy images, resulting in weather-resistant detection.

The overall loss function for robust monocular 3D object detection by dynamically enhancing feature representations using the model not only in clear weather but also in other bad weather conditions is expressed as Equation 12 below.

$${L}_{Total} = {L}_{OD} + {L}_{ckr} + {L}_{wae} \qquad [ Equation 12 ]$$

Here, L_{OD} is a detection loss for 3D object detection. By training the weather codebook Z and the weather-adaptive diffusion model 120 together with the object detection loss, the model may perform robust monocular 3D object detection by dynamically enhancing feature representations not only in clear weather but also in other bad weather conditions.

The method according to the embodiment of the present disclosure may be implemented in the form of program instructions that can be executed through various computer means and recorded on computer-readable media.

The computer-readable media may include program instructions, data files, data structures, etc., alone or in combination. The program instructions recorded on the computer-readable media may be specially designed and configured for embodiments of the present disclosure, or may be known and usable by those skilled in the art of computer software. The computer-readable recording media may include hardware devices configured to store and perform program instructions. Examples of the computer-readable recording media may include magnetic media such as hard disk, floppy disk, and magnetic tape, optical media such as CD-ROM and DVD, magneto-optical media such as floptical disk, ROM, RAM, and flash memory, etc. The program instructions may include not only machine language code such as that created by compilers, but also high-level language code that can be executed by computers through interpreters or the like.

As is apparent from the above description, the present disclosure provides the apparatus and method for monocular 3D object detection that are resistant to weather. According to the present disclosure, even if no separate weather information is provided from the outside, the model may determine weather by itself and respond accordingly to perform final 3D object detection. This allows the weather-adaptive diffusion model to learn the noise (weather differences) generated in various weather conditions to experience and cope with different patterns, thereby allowing it to adapt to various bad weather conditions.

In addition, the present disclosure can cope with sudden changes in weather since it determines weather for each image in real time and progress enhancement accordingly. This can provide safety and convenience for users by responding to different bad weather patterns and sudden changes in weather in actual autonomous driving situations.

The present disclosure is not limited to the above effects, and other effects of the present disclosure will be clearly understood by those skilled in the art from the above description.

Although the specific embodiments have been described with reference to the drawings, the present disclosure is not limited thereto. It will be apparent to those skilled in the art that various changes and modifications may be made without departing from the spirit and scope of the disclosure as defined in the following claims.

What is claimed is:

1. A method for monocular 3D object detection, comprising:
encoding input features of input images;
generating weather reference features that contain knowledge of reference weather and indicate a degree of enhancement for the input features by a weather codebook;
obtaining enhanced features by enhancing the input features with reference to the weather reference features by a weather-adaptive diffusion model; and
performing monocular 3D object detection using the enhanced features by a detection block.

2. The method according to claim 1, wherein the weather codebook is trained through a weather codebook training phase that comprises:
randomly initializing embedding weight parameters of the weather codebook;
obtaining a first enhanced feature by passing a first feature through a convolutional layer;
obtaining a first weather reference feature through a quantization process on each element of the first enhanced feature;
performing softmax and global average pooling (GAP) on the first feature and the first weather reference feature to generate first and second probabilities representing importance of each channel, respectively; and
training the weather codebook through use of a clear knowledge embedding (CKE) loss function calculated using Kullback-Leibler divergence for the first and second probabilities.

3. The method according to claim 2, wherein the weather codebook training phase further comprises:
obtaining a second enhanced feature by passing a second feature through a convolutional layer;
obtaining a second weather reference feature through the quantization process on each element of the second enhanced feature; and
training the weather codebook through use of a weather-invariant guiding (WIG) loss function that guides the second feature to be memorized as a feature of first weather using the first and second weather reference features.

4. The method according to claim 3, wherein in the weather codebook training phase, the weather codebook is trained using a clear knowledge recalling (CKR) loss function that adds the CKE loss function and the WIG loss function.

5. The method according to claim 4, wherein the weather-adaptive diffusion model is trained by performing forward and reverse processes in multiple time steps of fixed Markov Chain, and uses only the reverse process in its inference phase.

6. The method according to claim 5, wherein the weather-adaptive diffusion model is diffused using noise obtained by subtracting the first feature from the second feature for each of the multiple time steps in the forward process.

7. The method according to claim 6, wherein the weather-adaptive diffusion model generates the enhanced features by removing noise using a conditional autoencoder that receives a second feature at each corresponding one of the multiple time steps and the weather reference features from the weather codebook in the reverse process.

8. The method according to claim 7, wherein the weather-adaptive diffusion model calculates similarity between the input features and the weather reference features and transfers its enhancement to the input features.

9. The method according to claim 7, wherein the weather-adaptive diffusion model is trained using the following weather-adaptive enhancement (WAE) loss function that enables estimation of fog variants through several forward and reverse processes,
$${L}_{wae} = {E}_{{x}^{c} , {ϵ}_{n} ∼ F , t} [ {‖ {ϵ}_{n} - {ϵ}_{θ} ( {x}_{t}^{c} , t , {x}^{r} ) ‖}_{2}^{2} ]$$
where ∈ₙ is noise obtained by subtracting the second feature from the first feature, ∈_{θ} is estimated noise,
$${x}_{t}^{c}$$
is a first feature at a t-th time step, and x^{r} is a weather reference feature.

10. The method according to claim 3, wherein:
the reference weather is clear weather;
the first feature is a clear feature and the second feature is a foggy feature; and
the first enhanced feature is an enhanced feature for clear weather and the second enhanced feature is an enhanced feature for foggy weather.

11. An apparatus for monocular 3D object detection, comprising:
an encoder configured to encode input features of input images;
a weather codebook configured to generate weather reference features, which contain knowledge of reference weather and indicate a degree of enhancement for the input features;
a weather-adaptive diffusion model configured to obtain enhanced features by enhancing the input features with reference to the weather reference features; and
a detection block configured to perform monocular 3D object detection using the enhanced features.

12. The apparatus according to claim 11, wherein the weather codebook is trained through a weather codebook training phase that comprises:
randomly initializing embedding weight parameters of the weather codebook;
obtaining a first enhanced feature by passing a first feature through a convolutional layer;
obtaining a first weather reference feature through a quantization process on each element of the first enhanced feature;
performing softmax and global average pooling (GAP) on the first feature and the first weather reference feature to generate first and second probabilities representing importance of each channel, respectively; and
training the weather codebook through use of a clear knowledge embedding (CKE) loss function calculated using Kullback-Leibler divergence for the first and second probabilities.

13. The apparatus according to claim 12, wherein the weather codebook training phase further comprises:
obtaining a second enhanced feature by passing a second feature through a convolutional layer;
obtaining a second weather reference feature through the quantization process on each element of the second enhanced feature; and
training the weather codebook through use of a weather-invariant guiding (WIG) loss function that guides the second feature to be memorized as a feature of first weather using the first and second weather reference features.

14. The apparatus according to claim 13, wherein in the weather codebook training phase, the weather codebook is trained using a clear knowledge recalling (CKR) loss function that adds the CKE loss function and the WIG loss function.

15. The apparatus according to claim 13, wherein the weather-adaptive diffusion model is trained by performing forward and reverse processes in multiple time steps of fixed Markov Chain, and uses only the reverse process in its inference phase.

16. The apparatus according to claim 15, wherein the weather-adaptive diffusion model is diffused using noise obtained by subtracting the first feature from the second feature for each of the multiple time steps in the forward process.

17. The apparatus according to claim 16, wherein the weather-adaptive diffusion model generates the enhanced features by removing noise using a conditional autoencoder that receives a second feature at each corresponding one of the multiple time steps and the weather reference features from the weather codebook in the reverse process.

18. The apparatus according to claim 17, wherein the weather-adaptive diffusion model calculates similarity between the input features and the weather reference features and transfers its enhancement to the input features.

19. The apparatus according to claim 17, wherein the weather-adaptive diffusion model is trained using the following weather-adaptive enhancement (WAE) loss function that enables estimation of fog variants through several forward and reverse processes,
$${L}_{wae} = {E}_{{x}^{c} , {ϵ}_{n} ∼ F , t} [ {‖ {ϵ}_{n} - {ϵ}_{θ} ( {x}_{t}^{c} , t , {x}^{r} ) ‖}_{2}^{2} ]$$
where ∈ₙ is noise obtained by subtracting the second feature from the first feature, ∈_{θ} is estimated noise,
$${x}_{t}^{c}$$
is a first feature at a t-th time step, and x^{r} is a weather reference feature.

20. The apparatus according to claim 13, wherein:
the reference weather is clear weather;
the first feature is a clear feature and the second feature is a foggy feature; and
the first enhanced feature is an enhanced feature for clear weather and the second enhanced feature is an enhanced feature for foggy weather.
